(19) United States
(12) Patent Application Publication
(10) Pub. No.: US 2010/0089874 A1
(43) Pub. Date: Apr. 15, 2010

(54) SWITCHGEAR

(75) Inventors: Ayumu MORITA, Hitachi (JP); Masato Kobayashi, Hitachi (JP); Hironori Tonosaki, Hitachi (JP); Miki Yamazaki, Kashiwa (JP)

Correspondence Address: BRUNDIDGE & STANGER, P.C., 1700 DIAGONAL ROAD, SUITE 330, ALEXANDRIA, VA, 22314, US

(73) Assignee: Hitachi, Ltd.

(21) Appl. No.: 12/575,623

(22) Filed: Oct. 8, 2009

(30) Foreign Application Priority Data
Oct. 14, 2008 (JP) 2008-264746

(51) Int. Cl. H01H 3/00

(52) U.S. Cl. 218/154

(57) ABSTRACT

A switchgear is provided with interlocks that enhances safety and reliability. On a front face panel, a single line connection diagram, an indicator showing state of ON, OFF and disconnection, another indicator showing a state of an grounding switch, a selection mechanism for selecting manipulation of circuit break, disconnection and grounding, push button switches and for closing and opening a circuit breaker, a manipulation handle insertion hole for disconnecting and a manipulation handle insertion hole for grounding are provided. Depending on positions of a manipulation pin 12 of the selection mechanism, a machine and apparatus to be manipulated is selected. Further, other than the selection of the manipulation the selection mechanism mechanically couples with shutters respectively provided at the manipulation handle insertion hole for disconnecting and the manipulation handle insertion hole for grounding and realizes mechanical interlocks in series of manipulations between circuit break, disconnection and grounding.

### CLAIM OF PRIORITY

The present application claims priority from Japanese patent application serial No. 2008-264746 filed on Oct. 14, 2008, the content of which is hereby incorporated by reference into this application

### BACKGROUND OF THE INVENTION

1. Field of the Invention

The present invention relates to a switchgear and more specifically relates to a switchgear that enhances a manipulability and safety for a manual disconnecting switch or a manual grounding switch of which open and close operation is performed by inserting a handle.

2. Description of the Related Art

Generally, an interlock device is provided each between a disconnecting switch and an grounding switch or between a circuit breaker connected on the same circuit thereof for ensuring safety, and the interlock device is required to be simple, easy to manipulate and highly reliable as much as possible.

A conventional interlock device with a manual manipulation mechanism, as disclosed, for example, in JP-A-62-262608, is provided with a solenoid for locking a shutter for open and closing a handle insertion hole and is constituted to excite the solenoid under a condition that safety is ensured to release the lock of the shutter. Further, in such interlock device, the solenoid is locked in a non-excited state in case of the control power source failure based on safety priority concept.

### SUMMARY OF THE INVENTION

However, in the conventional art as above, in a site where an electric power can be used for the first time after a concerned switchgear receives an electric power, the interlock may forcedly be released, therefore, it was necessary to provide a separate countermeasure therefore. Further, because of the electrical interlock, other than the solenoid reliability for wirings, switches and the like connected to the solenoid is required in addition.

An object of the present invention is to provide a switchgear with a mechanical interlock that resolves the above problems, is simple and enhances reliability.

In order to achieve the above object, a switchgear of the present invention is characterized by being provided with a selection mechanism at a front face of the switchgear for manipulating a circuit breaker or a manual disconnecting switch, and is characterized in that the selection mechanism is mechanically coupled with a shutter provided for a manipulation handle insertion hole for the manual disconnecting switch and when disconnection is selected by the selection mechanism, the shutter is permitted to be opened.

Further, in order to achieve the above object, a switchgear of the present invention is characterized by being provided with a selection mechanism at a front face of the switchgear for manipulating a circuit breaker, a manual disconnecting switch or an grounding switch, and is characterized in that the selection mechanism is mechanically coupled with shutters provided for manipulation handle insertion holes for the manual disconnecting switch and the manual grounding switch and when disconnection or grounding is selected by the selection mechanism, the corresponding shutter is permitted to be opened.

Further, in the present invention as indicated above, the following measures are applied. Only when circuit break is selected by the selection mechanism, a circuit closing command for the circuit breaker is accepted. More specifically, a switch is provided that is turned ON when circuit break is selected by the selection mechanism, and the circuit closing command is provided to the circuit breaker via the switch. Further, the switchgear is constituted in such a manner that when the circuit breaker is in a circuit closed state, the selection mechanism and a link mechanism for the circuit breaker interfere to prevent the selection mechanism from being manipulated.

The switchgear is constituted in such a manner that when the shutter provided for the manipulation handle insertion hole for the manual disconnecting switch or the manual grounding switch is opened, the selection mechanism and the shutter interfere to prevent the selection mechanism from being manipulated. Further, the switchgear is constituted in such a manner that when the manual grounding switch is in a closed state, the selection mechanism and a link mechanism for the manual grounding switch interfere to prevent the selection mechanism from being manipulated.

Further, the switchgear of the present invention is constituted in such a manner that under a state where circuit break is selected by the selection mechanism, unless the manual disconnecting switch is opened, the selection mechanism is not permitted to select grounding. The switchgear of the present invention is constituted in such a manner that under a state where grounding is selected by the selection mechanism, unless the manual disconnecting switch is closed, the selection mechanism is not permitted to select circuit break.

According to the present invention, a switchgear with a mechanical interlock can be provided that is simple and enhances safety and reliability.

### BRIEF DESCRIPTION OF THE DRAWINGS

FIG. 1 is an outlook of a switchgear of the present invention.

FIG. 2 is a side cross sectional view of the switchgear of the present invention.

FIG. 3 is a side cross sectional view of an open and close portion mounted in the switchgear of the present invention.

FIG. 4 is a front view of a manipulation mechanism mounted in the switchgear of the present invention.

FIG. 5 is a cross sectional view of an electromagnet mounted in the switchgear of the present invention.

FIG. 6 is a view for explaining a structure of a manual manipulation mechanism for disconnecting mounted in the switchgear of the present invention.

FIG. 7 is a view for explaining an operation of the manual manipulation mechanism for disconnecting mounted in the switchgear of the present invention.

FIG. 8 is a view for explaining a structure of a manual manipulation mechanism for grounding mounted in the switchgear of the present invention.

FIG. 9 is a view for explaining an operation of the manual manipulation mechanism for grounding mounted in the switchgear of the present invention.

FIG. 10 is a front view of an interlock mechanism mounted in the switchgear of the present invention.

FIG. 11 is a side view of the interlock mechanism mounted in the switchgear of the present invention.

FIG. 12 is a front view of a selection mechanism mounted in the switchgear of the present invention.

FIG. 13 is a side view of the selection mechanism mounted in the switchgear of the present invention.

FIG. 14 is a view for explaining a movement of a manipulation pin from CB position in the switchgear of the present invention.

FIG. 15 is a view for explaining a movement of the manipulation pin from CB position to DS position in the switchgear of the present invention.

FIG. 16 is a view when the manipulation pin is at DS position in the switchgear of the present invention.

FIG. 17 is a view for explaining a movement of a manipulation pin from DS position to ES position in the switchgear of the present invention.

FIG. 18 is a view when the manipulation pin is at ES position in the switchgear of the present invention.

FIG. 19 is a view when a vacuum bulb for grounding is under closed state in the switchgear of the present invention.

FIG. 20 is a view for explaining a movement from ES position to DS position in the switchgear of the present invention.

### DETAILED DESCRIPTION OF THE PREFERRED EMBODIMENTS

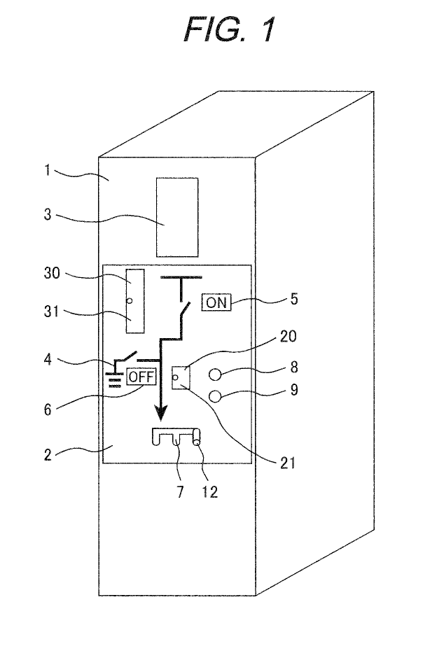

Herein below, an embodiment of the present invention will be explained with reference to FIG. 1.

### Embodiment 1

FIG. 1 shows an outlook of a switchgear 1 representing the embodiment of the present invention. As shown in the drawing, at a front face of the switchgear 1, a front face panel 2 and a protective relay 3 are provided. On the front face panel 2, a single line connection diagram 4 showing a constitution of the switchgear 1, an indicator 5 showing states of closed, opened and disconnection and another indicator 6 showing states of an grounding switch are provided.

Further, a selection mechanism 7 for selecting manipulation for circuit break, disconnection and grounding, push button switches 8 and 9 for closing and opening of a circuit breaker, a manipulation handle insertion hole 20 used for disconnecting and a manipulation handle insertion hole 30 used for grounding are provided.

In the present embodiment, according to positions of a manipulation pin 12 for the selection mechanism 7, a machine and apparatus to be manipulated can be selected.

Namely, the positions orderly from right to left represent circuit break (CB), disconnection (DS) and grounding (ES), and the state illustrated in FIG. 1 indicates that the circuit breaker can be manipulated. The selection mechanism 7 realizes not only the selection of the manipulation but also an interlock between a series of manipulation of circuit break, disconnection and grounding.

More specifically, the followings are performed. Only when the manipulation pin 12 selects circuit break, the circuit closing operation of the circuit breaker is permitted. Further, in the case when the circuit breaker is in a circuit closed state, the manipulation pin 12 is mechanically locked and selection of other manipulations is prohibited. When the manipulation pin 12 selects disconnection, a shutter 21 used for disconnecting manipulation provided at the manipulation handle insertion hole 20 used for disconnecting is rendered openable.

Further, unless the shutter 21 used for disconnecting manipulation is closed, the manipulation pin 12 cannot be displaced. When the manipulation pin 12 selects grounding, a shutter 31 used for grounding manipulation provided at the manipulation handle insertion hole 30 used for grounding is rendered openable. Likely in the above, unless the shutter 31 used for grounding manipulation is closed, the manipulation pin 12 cannot be displaced.

Further, when the grounding switch is closed and the switchgear 1 is rendered in an grounded state, since the manipulation pin 12 is mechanically locked, the circuit breaker or the disconnecting switch is rendered inmanipulatable.

Further, under a state where the selection mechanism 7 selects circuit break, unless the state is rendered to disconnection, the movement of the manipulation pin 12 to the grounding side is prevented. Likely, when the selection mechanism 7 selects grounding, unless the state is rendered from disconnection to OFF state, the selection mechanism 7 cannot select circuit break.

According to the switchgear 1 of the present invention as has been explained hitherto, since the manipulation object is clarified by the selection mechanism 7, such is useful for preventing erroneous manipulation. Further, with the manipulation pin 12 of the selection mechanism 7, since a variety of interlocks required for the switchgear can be realized, safety and reliability of the switchgear are enhanced.

### Embodiment 2

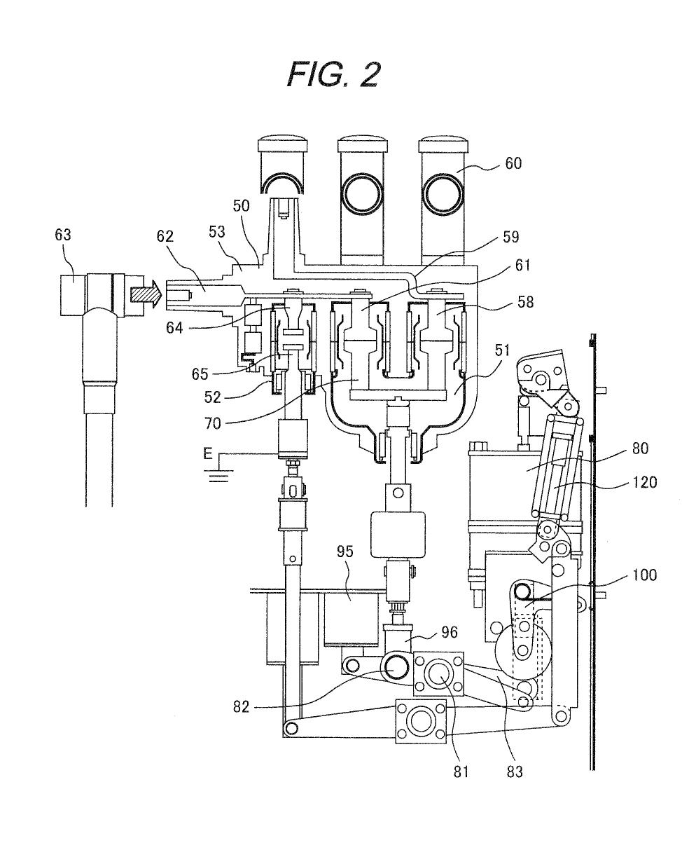

Now, a second embodiment of the present invention will be explained with reference to FIGS. 2 through 20.

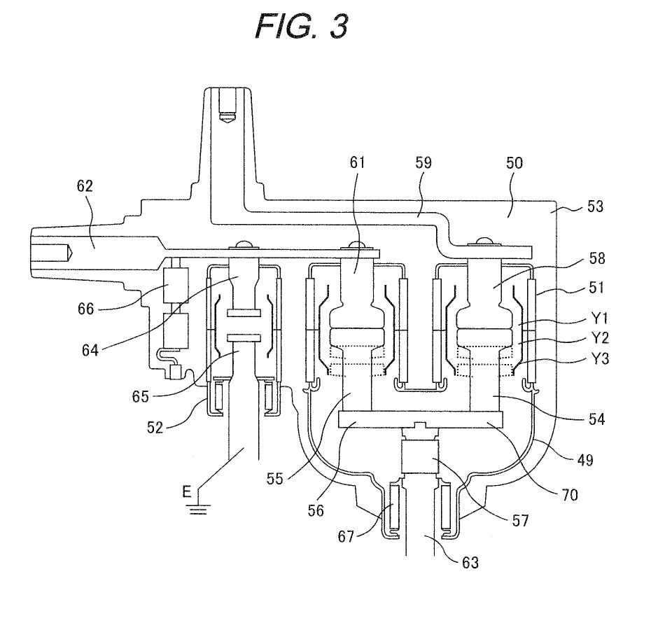

FIG. 2 is a side cross sectional view of a switchgear 1 and FIG. 3 is a side cross sectional view of a circuit opening and closing portion 50. As shown in the drawings, the circuit opening and closing portion 50 is constituted by a vacuum bulb 51 used for circuit braking and disconnecting and a vacuum bulb 52 used for grounding and they are molded by resin 53.

The three phase components of the circuit opening and closing portion 50 are arranged in parallel in the depth direction of the drawing. The vacuum bulb 51 used for circuit braking and disconnecting is constituted by a U shaped vacuum vessel 49 and inside thereof two pairs of contacts are accommodated.

Movable conductors 54 and 55 are fixed together to a connection conductor 56 and are electrically insulated from the outside with a ceramic made insulating rod 57. A stationary conductor 58 at the right side of FIG. 3, namely at the front face side of the switchgear 1 is fixed to a feeder 59 at a bus line side and is connected to a bus line 60 connecting between switchgears.

On the other hand, a stationary conductor 61 at the back face side of the switchgear 1 is connected to a cable 63 via a feeder 62 at a load side. Namely, in this switchgear 1, an electric power is fed to the load through a route of the bus line 60-the feeder 59 at the bus line side-the stationary conductor 58-the movable conductor 54-the connection conductor 56-the movable conductor 55-the stationary conductor 61-the feeder 62 at the load side-the cable 63.

The movable conductors 54 and 55 and the connection conductor 56 operate as a unitary body. Herein below, the movable conductors 54 and 55 and the connection conductor 56 are inclusively called as a movable portion 70. A manipulation rod 63 connected to the insulation rod 57 is fixed to the vacuum vessel 49 via a bellows 67 so as to permit the movable portion 70 operable while being maintained in vacuum tight.

The movable portion 70 of the vacuum bulb 51 used for circuit breaking and disconnecting stops at three positions, namely, at an ON position Y1 for feeding an electric power to a load, an OFF position Y2 for interrupting a current and a disconnecting position Y3 for ensuring an insulation performance for protecting workers from lightning surges.

A stationary conductor 64 of the vacuum bulb 52 used for grounding is fixed to the feeder 62 at the load side. In an instance such as during inspection that requires an grounding work, a movable conductor 65 that is grounded to E is contacted to the stationary conductor 64. Further, Numeral 66 is a capacitor and is used for a voltage detection to judge whether the load is applied of any voltage or of no voltage.

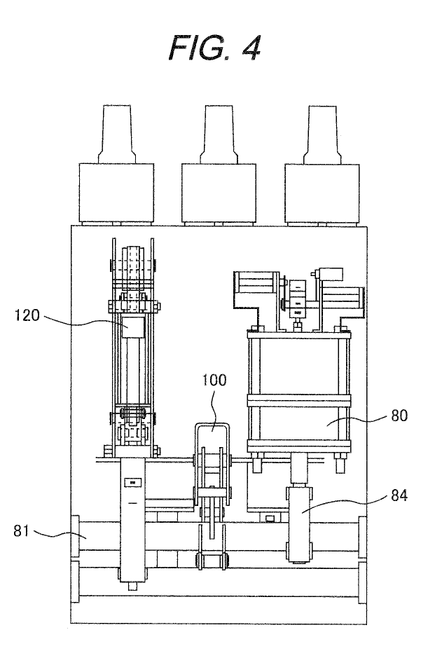

Now, a manipulation mechanism of the present switchgear 1 will be explained with reference to FIGS. 2 and 4.

The manipulation mechanism is constituted by an electromagnet 80 for driving the movable portion 70 of the vacuum bulb 51 used for circuit breaking and disconnecting between ON position Y1-OFF position Y2, the manual manipulation mechanism 100 used for disconnecting for driving between OFF position Y2-disconnecting position Y3 and the manual manipulation mechanism 120 used for grounding for manipulating the vacuum bulb 52 used for grounding.

### (1) Closing Operation of the Vacuum Bulb 51 Used for Circuit Breaking and Disconnecting (Off Position Y2→ON Position Y1)

The movable portion 70 of the vacuum bulb 51 used for circuit breaking and disconnecting is coupled to a lever 82 fixed to a first main shaft 81. Further, to the first main shaft 81 a lever 83 is fixed that is connected to the electromagnet 80 via a coupling metal part 84. Namely, with respect to the vacuum bulb 51 used for circuit breaking and disconnecting, when the first main shaft 81 is rotated in clockwise direction, the closing operation is performed and when rotated in anti clockwise direction the opening operation is performed.

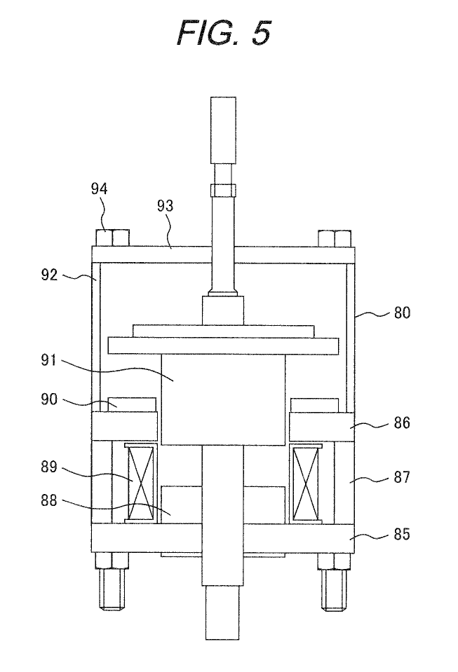

FIG. 5 shows an internal structure of the electromagnet 80. A stationary core thereof is constituted by a bottom steel plate 85, an intermediate steel plate 86, a steel tube 87 and a central core 88, and inside thereof a coil 89 is accommodated. Above the intermediate steel plate 86 a permanent magnet 90 is disposed. Further, after stacking a permanent magnet cover 92 and a top steel plate 93 on the intermediate steel plate 86, all the elements are caught and held by bolts at the four corners, thus, the electromagnet 80 is assembled.

Further, the intermediate steel plate 86 and the permanent magnet 89 are formed in annular shapes so as to permit a T shaped movable core 91 to pass through inside thereof. When the coil 89 is excited, the movable core 91 is attracted to the center core 88. At this moment, the movable core 91 is driven downward in the drawing and the vacuum bulb 51 used for circuit breaking and disconnecting is closed and the movable portion 70 stops at ON position Y1.

Further, in the closed state, since an interruption spring 95 and a contact pressing spring 96 providing a contacting force to the contacts are placed in an energized state, it is necessary to provide some measure for enduring the reaction force.

The magnetic fluxes of the permanent magnet 90 circulate through a route of the permanent magnet 90-the T shaped movable core 91-the central core 88-the bottom steel plate 85 the steel tube 87-the intermediate steel plate 86-the permanent magnet 90, and an attraction forces is generated between the permanent magnet 90-the movable core 91 and between the movable core 91-the central core 88. In this closed state, this attraction force endures the above reaction force and the energized state of the interruption spring 95 and the contact pressing spring 96 is maintained.

### (2) Opening Operation of the Vacuum Bulb 51 Used for a Circuit Breaking and a Disconnecting (on Position Y1→OFF Position Y2)

For the opening operation, the coil 89 is excited in the opposite direction as that of the closing operation, namely, is excited in the opposite direction to the fluxes of the permanent magnet 90. Through the excitation in the opposite direction, the magnetic force induced by the permanent magnet 90 is reduced, and the movable portion 70 is driven toward the opening direction by the force due to the interruption spring 95 and the contact pressing spring 96.

Herein, the roller 101 is fixed to a blade 103 rotating around a shaft 102 via a pin 104. Through abutting of the pin 112 with the roller 101, although the blade 103 tends to rotate in clockwise direction, since the rotation is prevented through an interference of the roller 101 with a first stopper pin 105, the opening state is maintained.

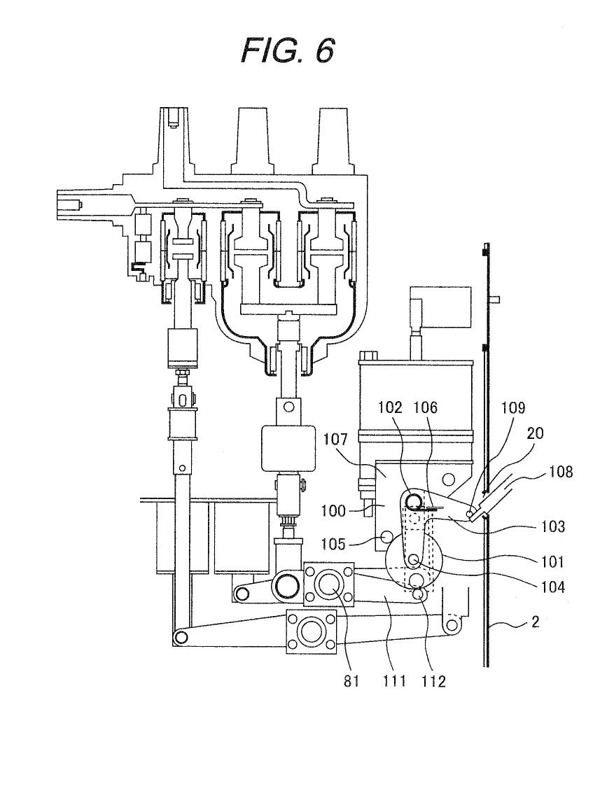

Further, one end of a coiled spring 106 that is disposed in a manner to wind around the shaft 102 is fixed to the blade 103 and the other end thereof is fixed to a frame 107. This is for keeping the roller 101 to stop at the position as shown in FIG. 6, even after releasing the interference between the pin 112 and the roller 101 through the closing of the vacuum bulb 51 used for circuit breaking and disconnecting.

### (3) Disconnection Operation 1 of the Vacuum Bulb 51 Used for Circuit Breaking and Disconnecting (OFF Position Y2→Disconnection Position Y3)

In the disconnection operation, a manipulation handle 108 used for disconnecting is inserted through the manipulation handle insertion hole 20 for disconnecting, is coupled to a pin 109 of the blade 103 and rotates the blade 103 in anti clockwise direction. After rotating the same slightly, and when a dead point where the pin 112, the pin 104 and the shaft 102 align on a straight line is exceeded, the first main shaft 81 and the blade 103 are rotated in anti clockwise direction by the force of the interruption spring 95.

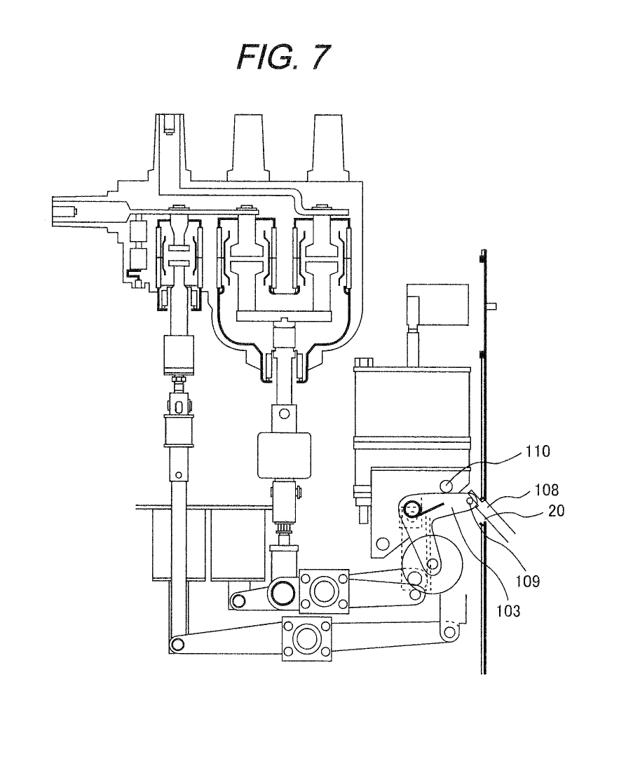

FIG. 7 shows a diagram for explaining the disconnection state. The blade 103 interferes with a second stopper pin 110 to stop the operation toward disconnection. The stopped position of the movable portion 70 at this moment corresponds to the disconnection position Y3.

Further, since the manipulation handle 108 used for disconnecting is operated in such a manner to jump up the pin 109 using the front face panel 2 as a fulcrum, there is no fear to suffer by the impacting force during the disconnection operation.

### (4) Disconnection Operation 2 of the Vacuum Bulb 51 Used for Circuit Breaking and Disconnecting (Disconnection Position Y3→OFF Position Y2)

This operation will be explained with reference to FIG. 7. The manipulation handle 108 used for disconnecting is inserted through the manipulation handle insertion hole 20 for disconnecting, is coupled to the pin 109 of the blade 103 using the upper side of the insertion hole 20 as a fulcrum and rotates the blade 103 in clockwise direction.

This manipulation is performed slowly while energizing the interruption spring 95. When the state as shown in FIG. 6 is restored after exceeding the dead point where the pin 112, the pin 104 and the shaft 102 align on a straight line, the movable portion 70 stops at the OFF position Y2.

### (5) Closing Operation of the Vacuum Bulb 52 for Grounding

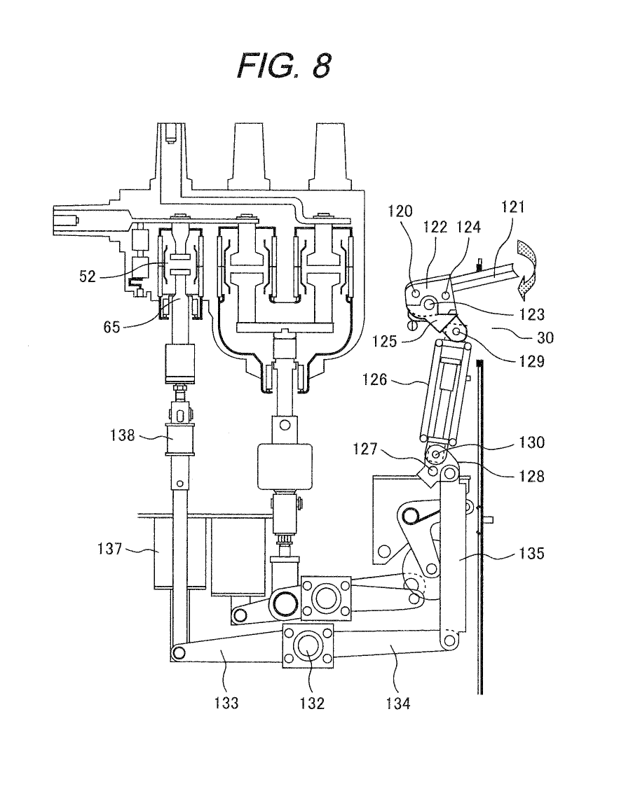

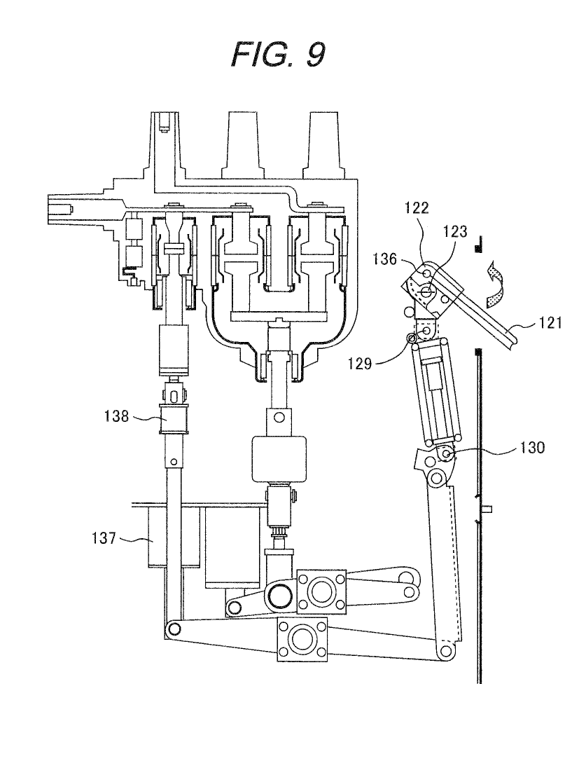

Now, an operation of the vacuum bulb 52 for grounding will be explained with reference to FIGS. 8 and 9. The movable conductor 65 of the vacuum bulb 52 for grounding is coupled to a lever 133 fixed to a second main shaft 132. Further, a lever 134 of the second main shaft 132 is connected to the manual manipulation mechanism 120 for grounding via a coupling metal part 135.

A manipulation handle 121 for grounding is inserted through the insertion hole 30 to a handle receiving metal fitting 122. When the manipulation handle 121 for grounding is manipulated downward as in FIG. 8, the handle receiving metal fitting 122 rotates in clockwise direction around a shaft 123.

At this moment, a pin 124 provided at the handle receiving fitting 122 interferes with a member 125 that rotates around the shaft 123, thereby, the member 125 also begins to rotate in clockwise direction. One end of a toggle spring 126 is connected to the member 125 and the other end thereof is connected to a blade 128 that rotates around a shaft 127.

Therefore, with the above operation, the toggle spring 126 is gradually compressed, and finally when a dead point where the shaft 123, a pin 129 that couples the member 125 and the toggle spring 126, a pin 130 that couples the toggle spring 126 and a blade 128 and the shaft 127 align on one straight line is exceeded, the second main shaft 132 is driven in the rotating direction by the energized force in the toggle spring 126. As a result, the movable conductor 65 of the vacuum bulb 52 for grounding is moved upward, namely closed (FIG. 9) Further, in the closing operation, an interruption spring 137 and a contact pressing spring 138 that provides a contacting force to the contact are rendered to a energized state.

### (6) Opening Operation of the Vacuum Bulb 52 for Grounding

In the opening operation, as shown in FIG. 9, the manipulation handle 121 for grounding is manipulated upward. The handle receiving metal fitting 122 rotates in anticlockwise direction around the shaft 123. At this moment, since the member 125 interferes with a pin 136 of the handle receiving metal fitting 122, the member 125 is moved at the same time.

When the dead point where the shaft 123, the pin 129 that couples the member 125 and the toggle spring 126, the pin 130 that couples the toggle spring 126 and the blade 128 and the shaft 127 align on one straight line is exceeded, the opening operation is performed, namely, the state as shown in FIG. 8 is restored by the force stored in the interruption spring 137 and the contact pressing spring 138 during the closing operation.

Further, during the opening operation since almost no energy is stored in the toggle spring 126, the operation is performed only depending on the interruption spring 137 and the contact pressing spring 138.

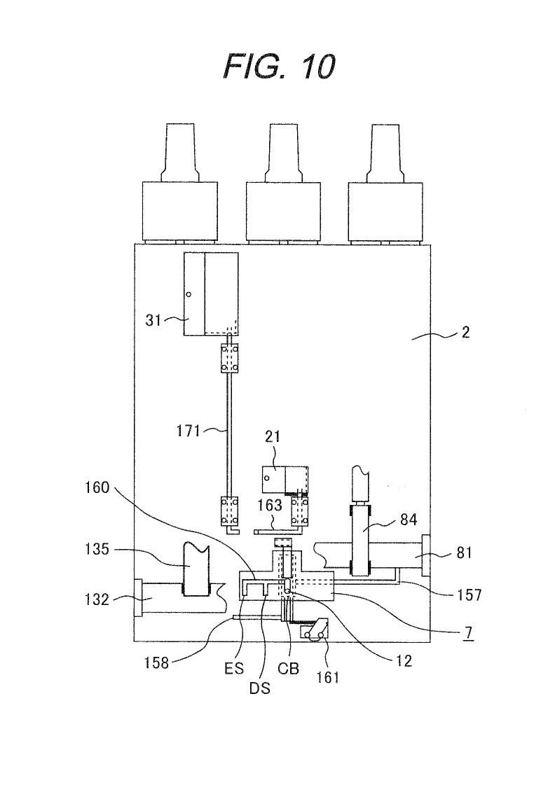

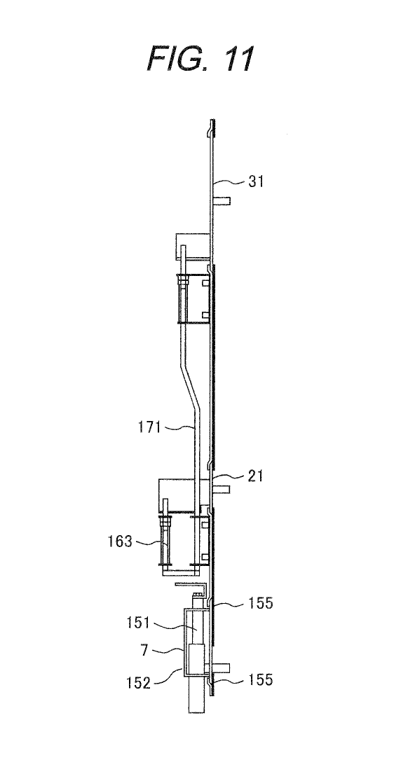

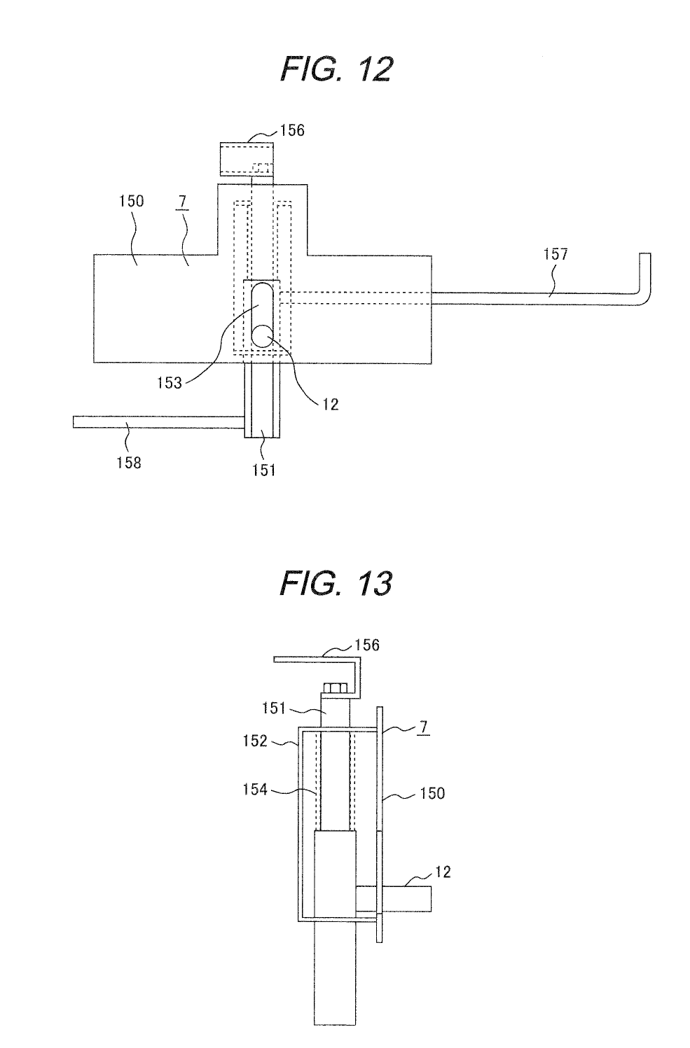

Herein below, an interlock device that is the gist of the present invention will be explained. FIG. 10 is a front view thereof and FIG. 11 is a side view thereof. Further, a structure of the selection mechanism 7 that selects an object to be manipulated is shown in FIGS. 12 and 13.

The selection mechanism 7 is constituted primarily by a panel 150 and a rod 151. To the panel 150 a rectangular member 152 is attached and the rod 151 passes through the bottom and top of the member 152.

Further, a return spring 154 is caught and held between the member 152 and the rod 151. At the side face of the rod 151 the manipulation pin 12 is fixed, and the manipulation pin 12 passes through an elliptical hole 153 provided at the panel 150. The panel 150 is only movable in the width direction of the switchgear 1 along rails 155 (FIG. 11) provided at the front panel 2. Accordingly, when the manipulation pin 12 is moved up and down along the elliptical hole 153 provided at the panel 150, only the rod 151 moves up and down without moving of the panel 150.

Further, to the rod 151, a first interlock pin 157 that interferes with the electromagnet 80 and the coupling metal part 84 of the first main shaft 81 and a second interlock pin 158 that interferes with the manual manipulation mechanism 120 for grounding and the coupling metal part 135 of the second main shaft 132 are fixed.

Further, at the upper tip end of the rod 151, a reversed C shape metal part 156 that couples with members for locking the shutters provided for the manipulation handle insertion hole 20 for disconnecting and the manipulation handle insertion hole 30 for grounding.

The front face panel 2 is provided with strips shaped (E shaped) groove 160, and the manipulation pin 12 passing through the groove 160 is constituted to be movable along the groove 160. Since the rod 151 is always forced downward by the return spring 154, the manipulation pin 12 stably positions respectively at circuit break position CB, disconnection position DS or grounding position ES.

Herein, it is implied that at the CB position the electromagnet 80, at the DS position the manual manipulation mechanism 100 for disconnecting and at the ES position the manual manipulation mechanism 120 for grounding are respectively manipulatable.

FIG. 10 shows an instance where the manipulation pin 12 is at the CB position and the vacuum bulb 51 for circuit breaking and disconnecting is in a closed state, namely, the movable portion 70 is at ON position Y1 as shown in FIG. 3. Since a closing command for the vacuum bulb 51 for circuit breaking and disconnecting is input via a limit switch 161, only when the manipulation pin 12 is at the CB position, the closing operation is possible. Further, through the interference between the first interlock pin 157 and the coupling metal part 84, an upward manipulation of the manipulation pin 12 is prevented.

From the above, the following three kinds of interlocks are realized; “Only when circuit break is selected by the selection mechanism, the circuit breaker can be closed”, “During manual manipulation for disconnecting or grounding an electrical control for the manipulation mechanism is disabled” and “In a state where the circuit breaker is closed, a manipulation for disconnecting or grounding is rendered impossible.”

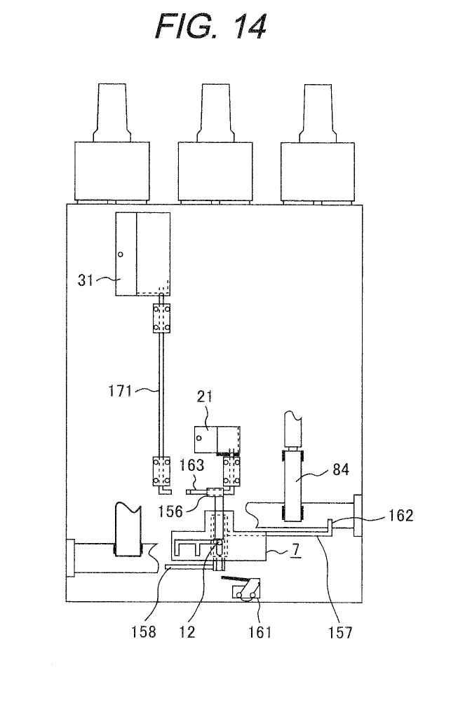

FIG. 14 shows an instance where the vacuum bulb 51 for circuit breaking and disconnecting is in an opened state and the movable portion 70 is at OFF position Y2 as shown in FIG. 3. In accordance with the opening operation, since the coupling metal part 84 moves upward, the manipulation pin 12 can be move upward and further to the IDS position.

However, due to the interference between a tip end bent portion 162 of the first interlock pin 157 and the coupling metal part 84, a movement of the manipulation pin 12 to the ES position is prevented. Namely, an interlock “After disconnecting manipulation, an grounding manipulation is enabled” is realized.

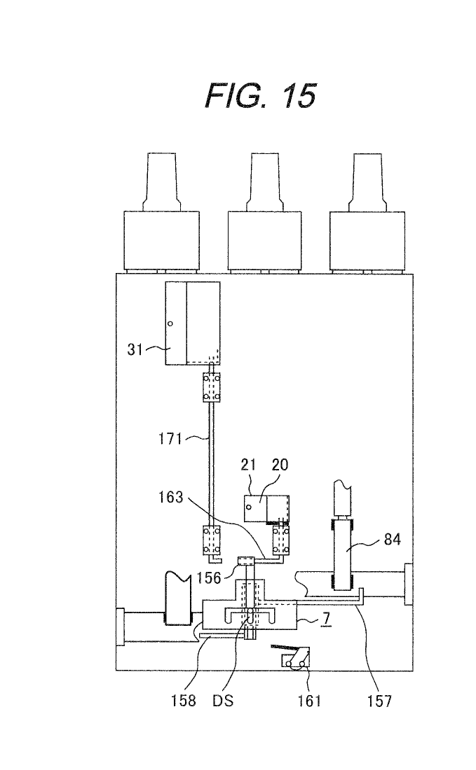

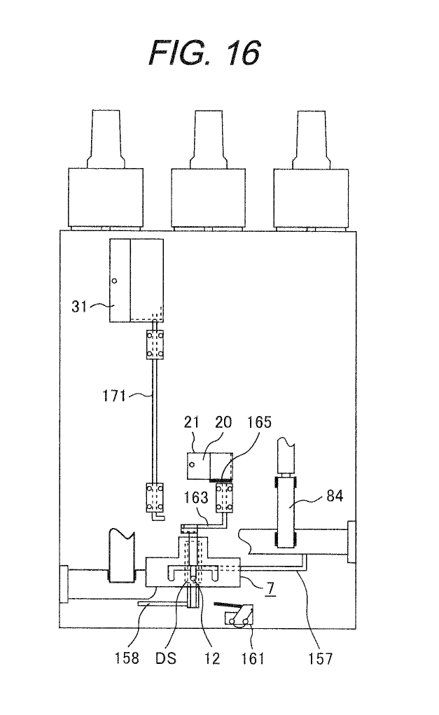

When the manipulation pin 12 moves to the DS position, a first shutter lock metal part 163 for locking the shutter 21 for manipulating disconnection provided at the manipulation handle insertion hole 20 for disconnecting couples with the inverted C shape metal part 156 at the upper part of the rod 151 (FIG. 15). As shown in FIG. 16, when the manipulation pin 12 is moved downward to the DS position, the first shutter clock metal part 163 is moved downward and the coupling between the shutter 21 for manipulating disconnection and the first shutter clock metal part 163 is released, the shutter 21 for manipulating disconnection becomes openable.

Further, under the state where the shutter 21 for manipulating disconnection is opened, even when the manipulation pin 12 is forced to move upward, such movement is prevented through the interference between the shutter 21 for manipulating disconnection and the first shutter clock metal part 163. Namely, an interlock “Only when disconnection is selected by the selection mechanism, the disconnecting operation can be performed” can be realized.

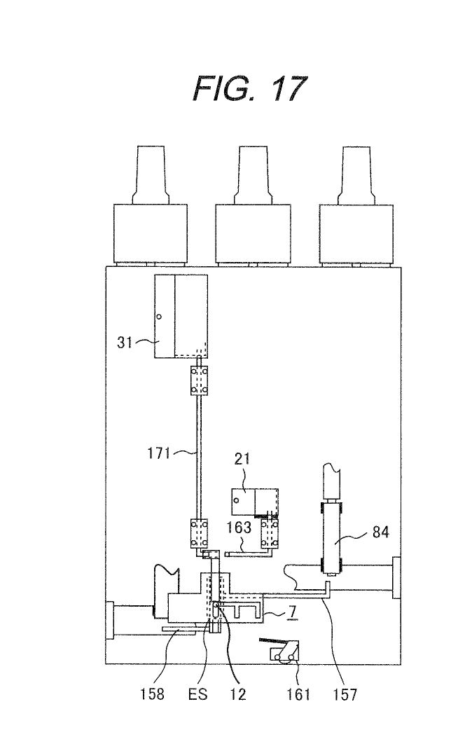

When the manipulation pin 12 is moved toward the ES position, the inverted C shape metal part 156 at the upper part of the rod 151 is released from the coupling with the first shutter lock metal part 163 for locking the shutter 21 for manipulating disconnection and is coupled with a second shutter lock metal part 171 for locking the shutter 31 for manipulating grounding as shown in FIG. 17.

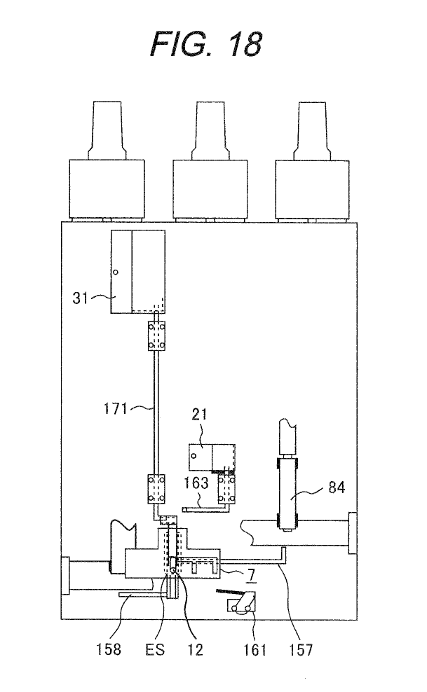

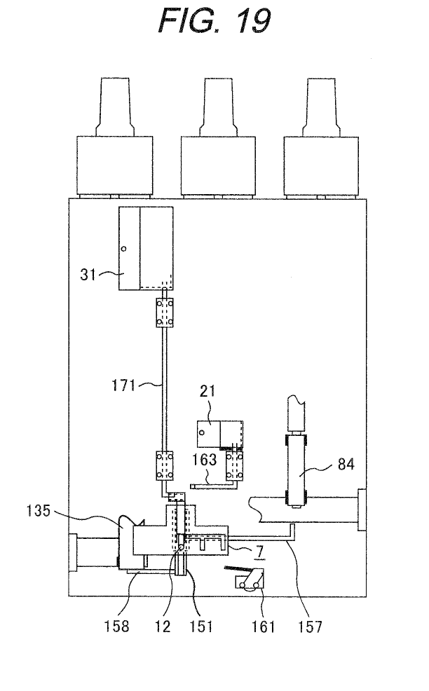

Under this condition, the second shutter lock metal part 171 is moved downward and when the manipulation pin 12 is moved downward to the ES position, the coupling between the shutter 31 for manipulating grounding and the second shutter lock metal part 171 is released and the shutter 31 for manipulating grounding becomes openable (FIG. 18). Even in this instance, like the above, unless the shutter 31 for manipulating grounding is closed, the upward movement of the manipulation pin 12 is prevented by the second shutter lock metal part 171.

Further, FIG. 19 shows a state where the vacuum bulb 52 for grounding is closed. Since the second interlock pin 158 fixed to the rod 151 interferes with the coupling member 135, an upward movement of the manipulation pin 12 is prevented. From the above, the following two interlocks are realized; “Only when the selection mechanism selects grounding, the grounding manipulation can be performed” and “Under a state where the grounding switch is closed, the disconnecting switch and the circuit breaker cannot be manipulated.

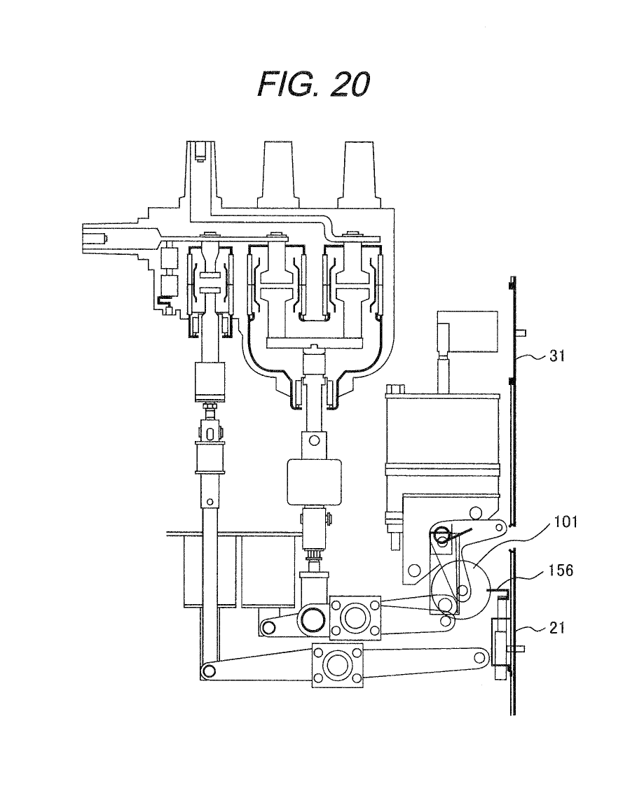

Further, as shown in FIG. 20, after the vacuum bulb 52 for grounding is opened, even when the manipulation pin 12 is forced to move toward the CB position, the interference between the inverted C shape metal part 156 at the upper part of the rod 151 and the roller 101 of the manual manipulation mechanism 100 for disconnecting prevents such movement. Namely, an interlock “After the disconnecting switch is closed (after the movable portion 70 is returned to OFF position Y2), a closing operation of the circuit breaker is rendered possible.”

As has been explained hitherto, with the switchgear 1 of the present invention, since a manipulation object is clarified by the selection mechanism 7, erroneous manipulations by workers can be prevented. Further, with the manipulation pin 12 of the selection mechanism 7, a variety of interlocks required for the switchgear can be mechanically realized, and safety and reliability are enhanced.

According to the present invention, with the manipulation pin at the front face panel, since a variety of interlocks can be mechanically realized, a switchgear of inexpensive and enhanced reliability can be provided.

What is claimed is:

1. A switchgear provided with a circuit breaker and a manual disconnecting switch,
characterized by comprising a selection mechanism at a front face of the switchgear for manipulating the circuit breaker or the manual disconnection switch, and characterized in that the selection mechanism is mechanically engaged by a link mechanism with a shutter provided for a manipulation handle insertion hole for the manual disconnecting switch and when disconnection is selected by the selection mechanism, the shutter is permitted to be opened by the link mechanism.

2. A switchgear according to claim 1 characterized in that only when circuit break is selected by the selection mechanism, a circuit closing command for the circuit breaker is permitted to be accepted.

3. A switchgear according to claim 2 characterized by further comprising a switch that is turned ON by the selection mechanism when the circuit break is selected by the selection mechanism, and characterized in that the circuit closing command is provided to the circuit breaker via the switch.

4. A switchgear according to claim 1 characterized in that, the link mechanism further comprises a link device engaged to the circuit breaker, and when the circuit breaker is in a circuit closed state, the selection mechanism and the link mechanism interfere each other to prevent the selection mechanism from being manipulated.

5. A switchgear according to claim 1 characterized in that when the shutter provided for the manipulation handle insertion hole for the manual disconnecting switch or the manual grounding switch is opened, the selection mechanism and the shutter interfere each other by the link mechanism to prevent the selection mechanism from being manipulated.

6. A switchgear provided with a circuit breaker, a manual disconnecting switch and a manual grounding switch, characterized by comprising a selection mechanism at a front face of the switchgear for manipulating the circuit breaker, the manual disconnecting switch or the grounding switch, and characterized in that the selection mechanism is mechanically engaged by a link mechanism with shutters provided for manipulation handle insertion holes for the manual disconnecting switch and the manual grounding switch and when disconnection or earth is selected by the selection mechanism, the corresponding shutter is permitted to be opened by the link mechanism.

7. A switchgear according to claim 6 characterized in that only when circuit break is selected by the selection mechanism, a circuit closing command for the circuit breaker is permitted to be accepted.

8. A switchgear according to claim 7 characterized by further comprising a switch that is turned ON by the selection mechanism when the circuit break is selected by the selection mechanism, and characterized in that the circuit closing command is provided to the circuit breaker via the switch.

9. A switchgear according to claim 6 characterized in that, the link mechanism further comprises a link device engaged to the circuit breaker, and when the circuit breaker is in a circuit closed state, the selection mechanism and the link mechanism interfere each other to prevent the selection mechanism from being manipulated.

10. A switchgear according to claim 6 characterized in that when the shutter provided for the manipulation handle insertion hole for the manual disconnecting switch or the manual grounding switch is opened, the selection mechanism and the shutter interfere each other to prevent the selection mechanism from being manipulated by the link mechanism.

11. A switchgear according to claim 6 characterized in that, the link mechanism further comprises a link device engaged to the manual grounding switch, and when the manual grounding switch is in a closed state, the selection mechanism and the link mechanism interfere each other to prevent the selection mechanism from being manipulated.

12. A switchgear according to claim 6 characterized in that, the link mechanism further comprises a link device engaged to the manual disconnecting switch, and the selection mechanism is not permitted to select earth, unless the manual disconnecting switch is opened, under a state where circuit break is selected by the selection mechanism.

13. A switchgear according to claim 6 characterized in that, the link mechanism further comprises a link device engaged to the manual disconnecting switch, and the selection mechanism is not permitted to select circuit break, unless the manual disconnecting switch is closed, under a state where earth is selected by the selection mechanism.
